(19) United States
(12) Patent Application Publication
(10) Pub. No.: US 2024/0081201 A1
(43) Pub. Date: Mar. 14, 2024

(54) Leaf Collector Robot Device

(71) Applicants: Dina Lindstrom, Leesburg, VA (US); Hala Amer, Fairfax, VA (US); Ahmed Abdelsalam, Fairfax, VA (US)

(72) Inventors: Dina Lindstrom, Leesburg, VA (US); Hala Amer, Fairfax, VA (US); Ahmed Abdelsalam, Fairfax, VA (US)

(21) Appl. No.: 18/191,373

(22) Filed: Mar. 28, 2023

Related U.S. Application Data
(60) Provisional application No. 63/404,734, filed on Sep. 8, 2022.

(51) Int. Cl. A01G 20/47; B25J 9/16; B25J 11/00; B25J 19/02

(52) U.S. Cl. CPC A01G 20/47; B25J 9/161; B25J 11/0055; B25J 19/02

(57) ABSTRACT

The present invention relates to a novel automatic leaf collector device. The device comprises a circular robot housing that is approximately two feet in height and that comprises three different module components. The first module component comprises a vacuum to suction in leaves, the second module comprises a set of cutting blades to cut the leaves and debris into powder, and the third module comprises a storage component to store the created powder. The device is programmable via a smartphone application to define the boundaries of the yard as well as when to operate. Thus, users can selectively activate the device to automate the process of leaf collection and disposable, saving extensive time and effort when completing yardwork.

### CROSS-REFERENCE TO RELATED APPLICATION

The present application claims priority to, and the benefit of, U.S. Provisional Application No. 63/404,734, which was filed on Sep. 8, 2022, and is incorporated herein by reference in its entirety.

### FIELD OF THE INVENTION

The present invention relates generally to the field of automatic leaf collector devices. More specifically, the present invention relates to a robot designed to collect, suction, and shred leaves, twigs, and other small environmental debris around a yard. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in automatic leaf collector devices. Generally, cleaning up leaves, twigs, and other yard debris during fall months can be exceptionally time consuming and exhausting. Further, raking leaves and then shoveling them into trash bags can also be frustrating. Additionally, constantly moving around environmental debris can trigger severe allergies in some people.

During autumn in many communities, homeowners must haul fallen leaves to the street curb in order that the local municipality may collect the leaves. For homeowners with large property and/or a great number of deciduous trees on the property (and correspondingly a great number of fallen leaves), this can be a time-consuming and burdensome task. Further, using garbage bags to haul fallen leaves can be frustrating, as the garbage bags are susceptible to tears. Thus, torn garbage bags may allow leaves, previously placed in the bag, to escape the confines of the bag, thereby causing the person performing the raking to have to redo some work.

Furthermore, a need remains for an automatic leaf collector device that can clean up leaves, twigs, and other yard debris during the fall months automatically. Accordingly, an automatic leaf collector device is disclosed which eliminates the need to manually rake and bag leaves and twigs, which saves extensive time and effort.

Therefore, there exists a long-felt need in the art for an automatic leaf collector device that provides users with a robot designed to collect, suction, and shred leaves, twigs, and other small environmental debris around a yard. There is also a long-felt need in the art for an automatic leaf collector device that allows users to program the device via a software application to show the robot where to collect leaves through the yard. Further, there is a long-felt need in the art for an automatic leaf collector device that includes three layers, such that a vacuum on the top layer suctions in leaves, a set of cutting blades in the middle section cuts leaves and debris into powder, and a base level stores the created powder. Moreover, there is a long-felt need in the art for a device that eliminates the need to manually rake leaves and twigs into piles, saving extensive time and effort especially during fall months. Further, there is a long-felt need in the art for an automatic leaf collector device that is programmable via a smartphone application to define the boundaries of the yard. Finally, there is a long-felt need in the art for an automatic leaf collector device that allows a user to selectively activate the device to automate the process of leaf collection and disposal.

The subject matter disclosed and claimed herein, in one embodiment thereof, comprises an automatic leaf collector device. The device comprises a circular robot housing that is approximately two feet in height which comprises three different module components. The first module component comprises a vacuum to suction in leaves, the second module comprises a set of cutting blades to cut the leaves and debris into powder, and the third module comprises a storage component to store the created powder. The shredded leaves and sticks can then be used as mulch or powder as compost. The device is programmable via a smartphone application to define the boundaries of the yard, as well as when to operate. Thus, users can selectively activate the device to automate the process of leaf collection and disposable, saving extensive time and effort when completing yardwork.

In this manner, the automatic leaf collector device of the present invention accomplishes all of the foregoing objectives and provides users with a device that eliminates the need to manually rake leaves and twigs into piles. The device is a robot designed to collect, suction, and shred leaves, twigs, and other small environmental debris around a yard.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an automatic leaf collector device. The device comprises a circular robot housing that is approximately two feet in height which comprises three different module components for operating the device to suction and shred leaves, twigs, and other debris from the yard. The shredded leaves and sticks can then be used as mulch or powder as compost. Accordingly, users can selectively activate the device to automate the process of leaf collection and disposable, saving extensive time and effort when completing yardwork.

In one embodiment, the robot housing may be circular, square, or rectangular in shape, and may be made from any of a number of possible materials, including heat-resistant plastics or polymers, such as polypropylene, polycarbonate, or acrylonitrile-butadiene-styrene (ABS). Typically, the robot housing may range in size from 2 to 4 square feet, and can be manufactured in varying sizes and shapes, depending on the needs and/or wants of a user.

Typically, the housing comprises a top, a bottom, and a curved side wall connecting the top and the bottom together for the circular configuration. The top, the bottom, and the curved side wall act to form a hollow interior cavity and opening. The hollow interior cavity is utilized for retaining the three module components, as well as electrical components necessary for operation.

In one embodiment, the first module comprises a suction means or vacuum for picking up leaves, twigs, and other debris from the yard. The vacuum can be any suitable vacuum as is known in the art, as long as it provides enough suction to pick up leaves, twigs, and other debris. Typically, leaves are pulled in from the sides of the housing as the device moves around the yard. There is generally openings or vents positioned between the curved side wall and the bottom of the housing which allows leaves and twigs to be sucked through and shredded. Any suitable openings can be utilized, as is known in the art, as long as a large amount of leaves can pass through at one time to be shredded. Typically, there are multiple openings and/or vents, but only one opening/vent is necessary for the collection of leaves.

In one embodiment, the second module comprises a blade hub with a plurality of blades. In one embodiment, three rotary blades are provided on the blade hub. The blade hub allows the blades to be easily removed for sharpening. In one embodiment, the blades preferably have parallel flat side faces. Further, the second module comprises a blade hub and an outlet duct portion communicating with the interior of the third module for storing the created powder. In addition to the action of the blades, the rapid rotary movement of the blades also causes a breaking up of the leaves with an outward centrifugal movement imparted to the leaves and portions thereof to move them toward the duct portion of the third module. In the event that sticks or stones enter the robot housing, the rotation of the blades permits passage of the sticks or stones and thus avoids damage to the blades.

In one embodiment, the device includes a third module which contains a central collection section. The central collection section is designed such that shredded leaves and/or other debris or objects may be accumulated within it after passing through the second module and being shredded. The central collection section can also comprise a bag or bin wherein shredded leaves and debris are funneled. The shredded leaves and debris within the bag or bin can then be used as mulch or powder for compost. The bag or bin also allows for easy removal of the shredded leaves and debris. Thus, the third module is detachably connected, or the bag/bin is detachable connected, such that it can be removed and emptied, as needed.

In operation, when the motor is operating causing rotation of the blades and creating a suction at the open portion of the first module, the first module picks up leaves and moves them to the interior of the second module, where the action of the blades is effective to comminute and shred the leaves and deliver the disintegrated leaves through the duct portion and into the third module, where they are retained for disposal or use as desired.

In one embodiment, the housing comprises a plurality of wheels. The plurality of wheels may be disposed on the underside of the housing and may allow the automatic leaf collector device to roll in any direction. In other words, the plurality of wheels may rotate, swivel, and pivot, based on a user's preference and/or commands. Specifically, the plurality of wheels may rotate, swivel, and pivot when the motor is activated. The plurality of wheels can be secured to an underside of the housing via any suitable securing means as is known in the art, such as bolts, screws, pins, etc. Further, any suitable wheels can be utilized as is known in the art, such as castors, rollers, swivel wheels, etc. In one embodiment, the plurality of wheels are rugged, all-terrain wheels which help the device travel around the yard during use.

In another embodiment, the housing comprises a sensor component, a processor, and a motor, but is not limited thereto. The sensor component may be disposed on the housing and may communicate with a plurality of sensor guides, which may be placed around the yard outlining the yard boundaries, the driveway, a garden, etc. The sensor component can also detect nearby objects to allow the device to avoid such objects when in motion.

In one embodiment, the housing comprises a plurality of exterior lights or reflectors for use in the dark.

In one embodiment, the processor may be disposed on or within the housing, and may be a CPU, a microprocessor, a controller, or any other type of computing device that may process programs and/or instructions, and which may control the other electrical components within the automatic leaf collector device. The processor may be connected to the sensor component and the motor, such that the processor causes the motor to be activated (i.e., turned on) when the processor, which includes a transmitter/receiver, receives a signal from a mobile device, for example.

In another embodiment, the motor may be any type of motor and/or control device to control the plurality of wheels to rotate and pivot.

In yet another embodiment, the mobile device or smart device may be a cellular telephone, a remote control, or any other device that may have wireless communication capabilities and may be connected to the internet. The mobile or smart device may perform any type of wireless communication, including, but not limited to, WIFI, BLUETOOTH, RFID, NFC, etc. The device further includes a wireless communication module and additional sensors which would allow the device to pair with a mobile application on a mobile or smart device. Once paired, a user could control the automatic leaf collector device via the mobile application.

As such, the user may use a mobile or smart device to input and/or program a date and time that the automatic leaf collector device is scheduled to move around the yard designated by the plurality of sensor guides to collect leaves, and a signal may be sent from the mobile device to the transmitter/receiver such that the processor (which may include a storage device) stores the date and time that the automatic leaf collector device is scheduled to move. Alternatively, the mobile or smart device may send a signal to the transmitter/receiver to control the automatic leaf collector device to move immediately.

When the transmitter/receiver receives the signal from the mobile/smart device to move, the processor may activate the motor, such that the plurality of wheels begin rotating. The sensor component causes the automatic leaf collector device to stay within the yard designated by the plurality of sensor guides, such that the automatic leaf collector device may stay between the plurality of sensor guides. As such, the motor may cause the plurality of wheels to rotate and pivot, thereby causing the automatic leaf collector device to move around the yard designated by the plurality of sensor guides (i.e., between the plurality of sensor guides).

In an alternative embodiment, the processor may include a GPS unit that may be programmed and/or controlled by the mobile or smart device to move to a predetermined location based on the input of the user. In other words, the GPS unit may be a global positioning device that communicates with satellites in order to determine a location of the automatic leaf collector device. The route of the device is optimized via GPS, ensuring the leaf collector device moves around the yard correctly. As such, the sensor component and the plurality of sensor guides may not be required when the GPS unit is included in the processor. Also, a display screen (which may also be an input unit/touch screen) on the mobile or smart device may display the automatic leaf collector device on a map as it is moving.

Furthermore, in one embodiment, the automatic leaf collector device may have an input unit including buttons or a touch screen (preferably waterproof) disposed thereupon to program the processor directly/manually, instead of requiring the processor to communicate with the mobile or smart device.

In another embodiment, the housing comprises a battery component.

In yet another embodiment, the housing rests on or against a charging dock or station within a home or garage. The charging dock or station can be any suitable shape or size that allows the device to be stored on the station and charged when not in use. The charging dock or station recharges the battery component and retains the device when not in use.

In yet another embodiment, the automatic leaf collector device is manufactured from lightweight metals or heat-resistant plastics or polymers, such as polypropylene, polycarbonate, or acrylonitrile-butadiene-styrene (ABS), etc.

In yet another embodiment, the automatic leaf collector device comprises a plurality of indicia.

In yet another embodiment, a method of automatically cleaning up leaves, twigs, and other yard debris is disclosed. The method includes the steps of providing an automatic leaf collector device comprising a circular robot housing comprising three different module components. The method also comprises vacuuming up leaves and twigs in a yard. Further, the method comprises cutting up the collected leaves and twigs into a powder. The method also comprises storing the powder in the device. Finally, the method comprises programming the device via a smartphone application.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-B illustrate a front perspective view of one embodiment of the automatic leaf collector device of the present invention disclosing the three module components in accordance with the disclosed architecture;

FIGS. 2A-B illustrate a front perspective view of one embodiment of the automatic leaf collector device of the present invention showing the wheels and vacuum in accordance with the disclosed architecture;

FIG. 3 illustrates a front perspective view of one embodiment of the automatic leaf collector device of the present invention in use in accordance with the disclosed architecture;

FIG. 4 illustrates a block diagram of the wireless communication module in communication with a smart device and the automatic leaf collector device of the present invention in accordance with the disclosed architecture; and

FIG. 5 illustrates a flowchart showing the method of automatically cleaning up leaves, twigs, and other yard debris in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an automatic leaf collector device that provides users with a robot designed to collect, suction, and shred leaves, twigs, and other small environmental debris around a yard. There is also a long-felt need in the art for an automatic leaf collector device that allows users to program the device via a software application to show the robot where to collect leaves through the yard. Further, there is a long-felt need in the art for an automatic leaf collector device that includes three layers, such that a vacuum on the top layer suctions in leaves, a set of cutting blades in the middle section cuts leaves and debris into powder, and a base level stores the created powder. Moreover, there is a long-felt need in the art for a device that eliminates the need to manually rake leaves and twigs into piles, saving extensive time and effort especially during fall months. Further, there is a long-felt need in the art for an automatic leaf collector device that is programmable via a smartphone application to define the boundaries of the yard. Finally, there is a long-felt need in the art for an automatic leaf collector device that allows a user to selectively activate the device to automate the process of leaf collection and disposal.

The present invention, in one exemplary embodiment, is a novel automatic leaf collector device. The device comprises a circular robot housing that is approximately two feet in height which comprises three different module components. The first module component comprises a vacuum to suction in leaves, the second module comprises a set of cutting blades to cut the leaves and debris into powder, and the third module comprises a storage component for storing the created powder. The device is programmable via a smartphone application to define the boundaries of the yard as well as when to operate. The present invention also includes a novel method of automatically cleaning up leaves, twigs, and other yard debris. The method includes the steps of providing an automatic leaf collector device comprising a circular robot housing comprising three different module components. The method also comprises vacuuming up leaves and twigs in a yard. Further, the method comprises cutting up the collected leaves and twigs into a powder. The method also comprises storing the powder in the device. Finally, the method comprises programming the device via a smartphone application.

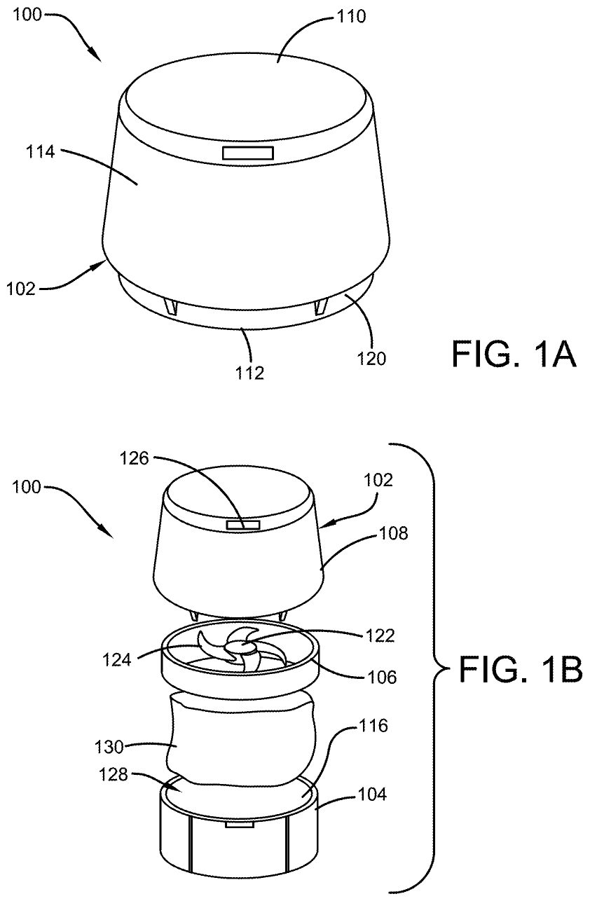

Referring initially to the drawings, FIGS. 1A-B illustrate a perspective view of one embodiment of the automatic leaf collector device 100 of the present invention. In the present embodiment, the automatic leaf collector device 100 is an improved leaf collector device 100 that provides users with a robot designed to collect, suction, and shred leaves, twigs, and other small environmental debris around a yard. Specifically, the automatic leaf collector device 100 comprises a housing 102 with three different module components 104, 106, 108 for operating the device 100 to suction and shred leaves, twigs, and other debris from the yard. The shredded leaves and sticks can then be used as mulch or powder as compost. Accordingly, users can selectively activate the device 100 to automate the process of leaf collection and disposable, saving extensive time and effort when completing yardwork.

Generally, the robot housing 102 may be circular, square, or rectangular in shape and may be made from any of a number of possible materials, including heat-resistant plastics or polymers, such as polypropylene, polycarbonate, or acrylonitrile-butadiene-styrene (ABS). Typically, the robot housing 102 may range in size from 2 to 4 square feet, and can be manufactured in varying sizes and shapes, depending on the needs and/or wants of a user.

Typically, the housing 102 comprises a top 110, a bottom 112, and a curved side wall 114 connecting the top 110 and the bottom 112 together for the circular configuration. The top 110, the bottom 112, and the curved side wall 114 act to form a hollow interior cavity 116 and opening. The hollow interior cavity 116 is utilized for retaining the three module components 104, 106, 108, as well as electrical components necessary for operations.

Further, the first module 104 comprises a suction means or vacuum 118 for picking up leaves, twigs, and other debris from the yard. The vacuum 118 can be any suitable vacuum as is known in the art, as long as it provides enough suction to pick up leaves, twigs, and other debris. Typically, leaves are pulled in from the sides of the housing 102 as the device 100 moves around the yard. There is generally openings or vents 120 positioned between the curved side wall 114 and the bottom 112 of the housing 102 which allows leaves and twigs to be sucked through and shredded. Any suitable openings 120 can be utilized, as is known in the art, as long as a large amount of leaves can pass through at one time to be shredded. Typically, there are multiple openings and/or vents 120, but only one opening/vent 120 is necessary for the collection of leaves.

Additionally, the second module 106 comprises a blade hub 122 with a plurality of blades 124. In one embodiment, three rotary blades 124 are provided on the blade hub 122. The blade hub 122 allows the blades 124 to be easily removed for sharpening. In one embodiment, the blades 124 preferably have parallel flat side faces. Further, the second module 106 comprises a blade hub 122 and an outlet duct portion 126 communicating with the interior of the third module 108 for storing the created powder. In addition to the action of the blades 124, the rapid rotary movement of the blades 124 also causes a breaking up of the leaves with an outward centrifugal movement imparted to the leaves and portions thereof to move them toward the duct portion 126 of the third module 108. In the event that sticks or stones enter the robot housing 102, the rotation of the blades 124 permits passage of the sticks or stones and thus avoids damage to the blades 124.

Furthermore, the device 100 includes a third module 108 which contains a central collection section 128. The central collection section 128 is designed such that shredded leaves and/or other debris or objects may be accumulated within it after passing through the second module 106 and being shredded. The central collection section 128 can also comprise a bag or bin 130 wherein shredded leaves and debris are funneled. The shredded leaves and debris within the bag or bin 130 can then be used as mulch or powder for compost. The bag or bin 130 also allows for easy removal of the shredded leaves and debris. Thus, the third module 108 is detachably connected, and/or the bag/bin 130 is detachably connected, such that it can be removed and emptied, as needed.

In operation, when the motor is operating causing rotation of the blades 124 and creating a suction at the open portion 120 of the first module 104, the first module 104 picks up leaves and moves them to the interior of the second module 106 where the action of the blades 124 is effective to comminute and shred the leaves and deliver the disintegrated leaves through the duct portion 126 and into the third module 108 where they are retained for disposal or use as desired.

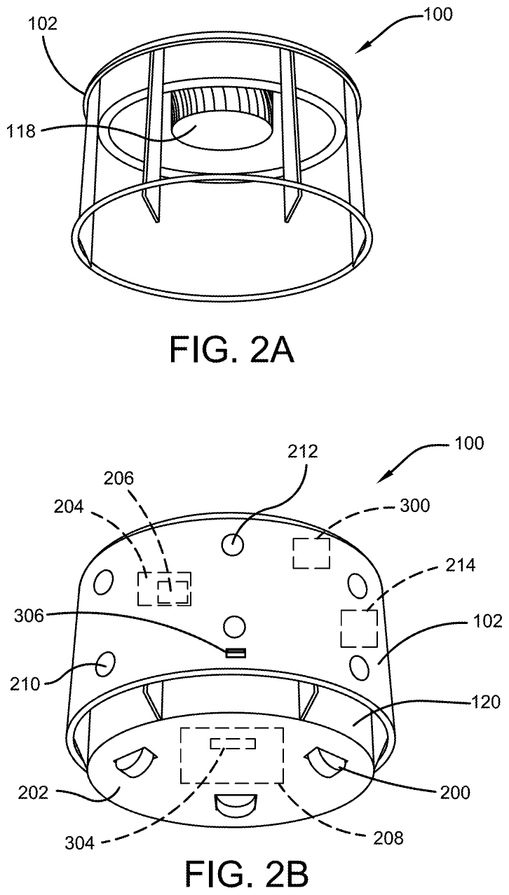

As shown in FIGS. 2A-B, the housing 102 comprises a plurality of wheels 200. The plurality of wheels 200 may be disposed on the underside 202 of the housing 102 and may allow the automatic leaf collector device 100 to roll in any direction. In other words, the plurality of wheels 200 may rotate, swivel, and pivot, based on a user's preference and/or commands. Specifically, the plurality of wheels 200 may rotate, swivel, and pivot when the motor is activated. The plurality of wheels 200 can be secured to an underside 202 of the housing 102 via any suitable securing means as is known in the art, such as bolts, screws, pins, etc. Further, any suitable wheels 200 can be utilized as is known in the art, such as castors, rollers, swivel wheels, etc. In one embodiment, the plurality of wheels 200 are rugged, all-terrain wheels which help the device 100 travel around the yard during use. Additionally, any suitable number of wheels 200 can be utilized as is known in the art, depending on the needs and/or wants of a user.

Furthermore, the housing 102 comprises a sensor component 204, a processor 206, and a motor 208, but is not limited thereto. The sensor component 204 may be disposed on the housing 102 and may communicate with a plurality of sensor guides 210, which may be placed around the yard, outlining the yard boundaries, the driveway, a garden, etc. The sensor component 204 can also detect nearby objects to allow the device 100 to avoid such objects when in motion. Typically, the sensor component 204 could detect moving objects, such as people and animals, as well as stationary objects, such as rocks, trees, etc.

Additionally, the housing 102 comprises a plurality of exterior lights 212 or reflectors for use in the dark. Any suitable number of exterior lights 212 can be utilized as is known in the art, depending on the needs and/or wants of a user. The lights 212 and/or reflectors allow for ease of use during lowlight or nighttime hours.

Further, the processor 206 may be disposed on or within the housing 102, and may be a CPU, a microprocessor, a controller, or any other type of computing device that may process programs and/or instructions, and which may control the other electrical components within the automatic leaf collector device 100. The processor 206 may be connected to the sensor component 204 and the motor 208, such that the processor 206 causes the motor 208 to be activated (i.e., turned on) when the processor 206, which includes a transmitter/receiver 214, receives a signal from a mobile or smart device 400.

Additionally, the motor 208 may be any type of motor and/or control device to control the plurality of wheels 200 to rotate and pivot as is known in the art, depending on the needs and/or wants of a user.

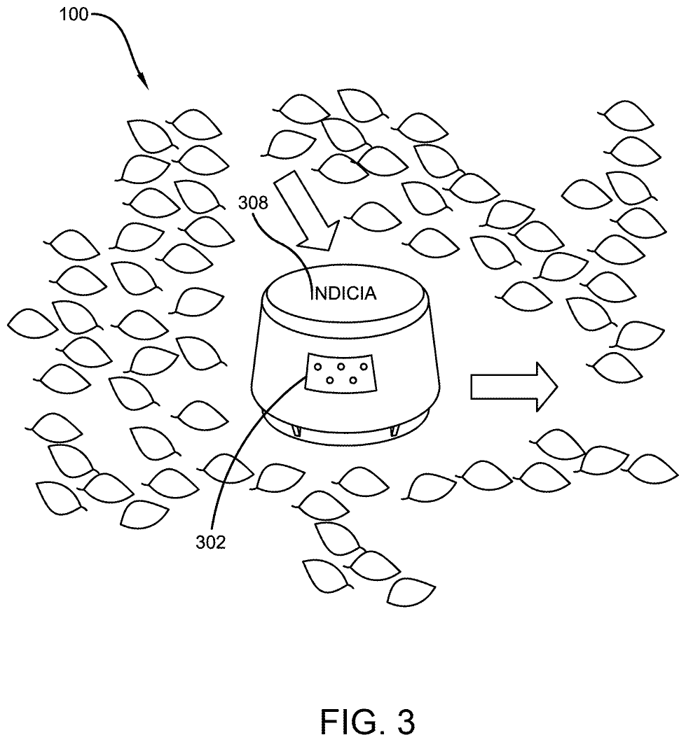

As shown in FIG. 3, when the transmitter/receiver 214 receives the signal from the mobile/smart device 400 to move, the processor 206 may activate the motor 208, such that the plurality of wheels 200 begin rotating. The sensor component 204 causes the automatic leaf collector device 100 to stay within the yard designated by the plurality of sensor guides 210, such that the automatic leaf collector device 100 may stay between the plurality of sensor guides 210. As such, the motor 208 may cause the plurality of wheels 200 to rotate and pivot, thereby causing the automatic leaf collector device 100 to move around the yard designated by the plurality of sensor guides 210 (i.e., between the plurality of sensor guides 210).

Additionally, the processor 206 may include a GPS unit 300 that may be programmed and/or controlled by the mobile or smart device 400 to move to a predetermined location based on an input of the user. In other words, the GPS unit 300 may be a global positioning device that communicates with satellites in order to determine a location of the automatic leaf collector device 100. The route of the device 100 is optimized via GPS 300, ensuring the leaf collector device 100 moves around the yard correctly. As such, the sensor component 204 and the plurality of sensor guides 210 may not be required when the GPS unit 300 is included in the processor 206. Also, a display screen 402 (which may also be an input unit/touch screen) on the mobile or smart device 400 may display the automatic leaf collector device 100 on a map as it is moving.

Furthermore, in one embodiment, the automatic leaf collector device 100 may have an input unit 302 including buttons or a touch screen (preferably waterproof) disposed thereupon to program the processor 206 directly/manually instead of requiring the processor 206 to communicate with the mobile or smart device 400.

In another embodiment, the housing 102 comprises a battery component 304. The battery component 304 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the leaf collector device 100. Throughout this specification, the term “battery” may be used interchangeably to refer to one or more wet or dry cells or batteries of cells in which chemical energy is converted into electricity and used as a source of DC power. References to recharging or replacing the battery 304 may refer to recharging or replacing individual cells, individual batteries of cells, or a package of multiple battery cells as is appropriate for any given battery technology that may be used. In addition, a rechargeable embodiment of the battery 304 may be recharged using a USB port (not shown), wherein the USB port is a USB-A, USB-B, Micro-B, Micro-USB, Mini-USB, or USB-C port, etc.

In yet another embodiment, the housing 102 rests on or against a charging dock or station 306 within a home or garage. The charging dock or station 306 can be any suitable shape or size and allows the device 100 to be stored on the station 306 and charged when not in use. The charging dock or station 306 recharges the battery component 304 and retains the device 100 when not in use.

Further, the automatic leaf collector device 100 is manufactured from lightweight metals or heat-resistant plastics or polymers, such as polypropylene, polycarbonate, or acrylonitrile-butadiene-styrene (ABS), etc.

Additionally, the automatic leaf collector device 100 comprises a plurality of indicia 308. The housing 102 of the device 100 may include advertising, trademark, or other letters, designs, or characters, printed, painted, stamped, or integrated into the housing 102, or any other indicia 308 as is known in the art. Specifically, any suitable indicia 308 as is known in the art can be included, such as, but not limited to, patterns, logos, emblems, images, symbols, designs, letters, words, characters, animals, advertisements, brands, etc., that may or may not be yard, leaf, or brand related.

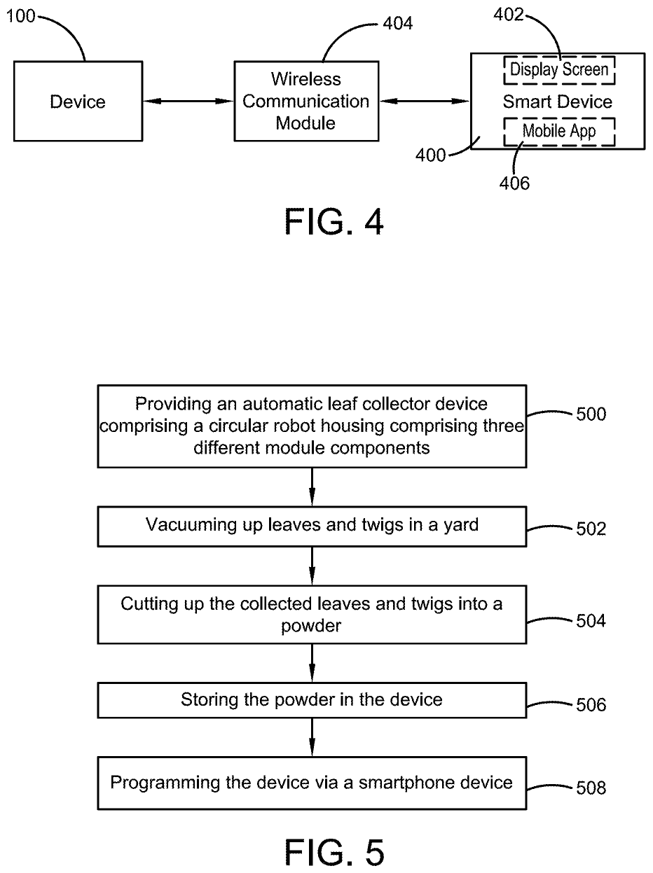

FIG. 4 illustrates a block diagram of the wireless communication module 404 in communication with a smart device 400 and the automatic leaf collector device 100 of the present invention. The automatic leaf collector device 100 includes a wireless communications module 404 and additional sensors which would allow the device 100 to pair with a mobile application 406 on a smart device 400. Once paired, a user could control the automatic leaf collector device 100 via the mobile application 406.

As shown in FIG. 4, the mobile device or smart device 400 may be a cellular telephone, a remote control, or any other device that may have wireless communication capabilities and may be connected to the internet. The mobile or smart device 400 may perform any type of wireless communication, including, but not limited to, WIFI, BLUETOOTH, RFID, NFC, etc. The device 100 further includes a wireless communication module 404 and additional sensors which would allow the device 100 to pair with a mobile application 406 on a mobile or smart device 400. Once paired, a user could control the automatic leaf collector device 100 via the mobile application 406.

As such, the user may use a mobile or smart device 400 to input and/or program a date and time that the automatic leaf collector device 100 is scheduled to move around the yard designated by the plurality of sensor guides 210 to collect leaves, and a signal may be sent from the mobile device 400 to the transmitter/receiver 214 such that the processor 206 (which may include a storage device) stores the date and time that the automatic leaf collector device 100 is scheduled to move. Alternatively, the mobile or smart device 400 may send a signal to the transmitter/receiver 214 to control the automatic leaf collector device 100 to move immediately.

FIG. 5 illustrates a flowchart of the method of automatically cleaning up leaves, twigs, and other yard debris. The method includes the steps of at 500, providing an automatic leaf collector device comprising a circular robot housing comprising three different module components. The method also comprises at 502, vacuuming up leaves and twigs in a yard. Further, the method comprises at 504, cutting up the collected leaves and twigs into a powder. The method also comprises at 506, storing the powder in the device. Finally, the method comprises at 508, programming the device via a smartphone application.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “automatic leaf collector device”, “leaf collector device”, and “device” are interchangeable and refer to the automatic leaf collector device 100 of the present invention.

Notwithstanding the foregoing, the automatic leaf collector device 100 of the present invention can be of any suitable size and configuration as is known in the art without affecting the overall concept of the invention, provided that it accomplishes the above-stated objectives. One of ordinary skill in the art will appreciate that the automatic leaf collector device 100 as shown in FIGS. 1-5 are for illustrative purposes only, and that many other sizes and shapes of the automatic leaf collector device 100 are well within the scope of the present disclosure. Although the dimensions of the automatic leaf collector device 100 are important design parameters for user convenience, the automatic leaf collector device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An automatic leaf collector device that automatically collects, suctions, and shreds leaves, twigs and other debris around a yard, the automatic leaf collector device comprising:
a housing with a plurality wheels; and
a first module component;
a second module component; and
a third module component;
wherein the first, the second and the third module components are secured within the housing; and
further wherein the housing operates to suction and shred the leaves, twigs and other debris from the yard.

2. The automatic leaf collector device of claim 1, wherein the housing is circular in configuration and comprises a top, a bottom, and a curve side wall connecting the top and the bottom together to form a hollow interior cavity.

3. The automatic leaf collector device of claim 2, wherein the first module component comprises a vacuum for picking up the leaves, twigs and other debris from the yard.

4. The automatic leaf collector device of claim 3, wherein the housing comprises openings positioned between the curved side wall and the bottom of the housing, which allows the leaves, twigs and other debris to be sucked through and shredded.

5. The automatic leaf collector device of claim 4, wherein the second module component comprises a blade hub with a plurality of blades.

6. The automatic leaf collector device of claim 5, wherein three rotary blades are provided on the blade hub.

7. The automatic leaf collector device of claim 6, wherein the second module component comprises an outlet duct portion communicating with an interior of the third module component.

8. The automatic leaf collector device of claim 7, wherein the third module comprises a central collection section for storing shredded leaves and other debris which pass from the second module.

9. The automatic leaf collector device of claim 8, wherein the central collection section comprises a bin to store the shredded leaves, twigs and other debris.

10. The automatic leaf collector device of claim 9, wherein the housing comprises a sensor component, a processor, and a motor, such that the sensor component is disposed on the housing and communicates with a plurality of sensor guides, which may be placed around the yard, outlining yard boundaries.

11. The automatic leaf collector device of claim 10, wherein the housing comprises a plurality of exterior lights for use at night or in other low light conditions.

12. The automatic leaf collector device of claim 11, wherein the processor is disposed within the housing, and may be connected to the sensor component and the motor, such that the processor causes the motor to be activated when the processor, which includes a transmitter/receiver, receives a signal from a smart device.

13. The automatic leaf collector device of claim 12, wherein the housing comprises a wireless communications module and additional sensors which would allow the automatic leaf collector device to pair with a mobile application on a smart device, and once paired, a user could control the automatic leaf collector device via the mobile application.

14. An automatic leaf collector device that automatically collects, suctions, and shreds leaves, twigs and other debris from around a yard, the automatic leaf collector device comprising:
a housing comprising a plurality wheels, a sensor component, a processor, and a motor, such that the sensor component is disposed on the housing and communicates with a plurality of sensor guides, which may be placed around the yard, outlining yard boundaries;
a first module component comprising a vacuum for picking up the leaves, twigs and other debris from the yard;
a second module component comprising a blade hub with a plurality of blades; and
a third module component comprising a central collection section for storing shredded leaves, twigs and other debris which pass from the second module; and
wherein the first, the second and the third module components are secured within the housing;
wherein the housing comprises openings positioned between the curved side wall and the bottom of the housing, which allows the leaves, twigs and other debris to be sucked through and shredded;
wherein the housing operates to suction and shred the leaves, twigs and other debris from the yard;
wherein the processor is disposed within the housing, and may be connected to the sensor component and the motor, such that the processor causes the motor to be activated when the processor, which includes a transmitter/receiver, receives a signal from a smart device; and
further wherein the housing comprises a wireless communications module and additional sensors which would allow the automatic leaf collector device to pair with a mobile application on a smart device, and once paired, a user could control the automatic leaf collector device via the mobile application.

15. The automatic leaf collector device of claim 14, wherein the processor may include a GPS unit that may be programmed and controlled by the smart device.

16. The automatic leaf collector device of claim 15 further comprising an input unit including buttons or a touch screen disposed thereupon to program the processor directly.

17. The automatic leaf collector device of claim 16 further comprising a battery component.

18. The automatic leaf collector device of claim 17, wherein the housing rests on or against a charging dock within a garage to charge the battery component when not in use.

19. The automatic leaf collector device of claim 18 further comprising a plurality of indicia.

20. A method of automatically cleaning up leaves, twigs and other yard debris, the method comprising the following steps:
providing an automatic leaf collector device comprising a circular robot housing comprising three different module components;
vacuuming up leaves and twigs in a yard;
cutting up the collected leaves and twigs into a powder;
storing the powder in the device; and
programming the device via a smartphone application.
